(19) United States
(12) Patent Application Publication
(10) Pub. No.: US 2023/0384063 A1
(43) Pub. Date: Nov. 30, 2023

(54) Autonomous Unmanned Waterside Security Barrier Propulsion and Gate System, Preferably With Unmanned Barrier Gate (UBG)

(71) Applicant: Oceanetics, Inc., Annapolis, MD (US)

(72) Inventors: Erick Knezek, Lafayette, LA (US); Matthew Marcy, Bluemont, VA (US); Mark Wood, Tarpon Springs, FL (US); David Delleart, Washington, MO (US); William Newton Seelig, Rockville, MD (US); Christopher Pacheco, Rockville, RI (US)

(21) Appl. No.: 18/031,422

(22) PCT Filed: Oct. 18, 2021
(86) PCT No.: PCT/US2021/055352

§ 371 Date: Apr. 12, 2023

Related U.S. Application Data
(60) Provisional application No. 63/092,576, filed on Oct. 16, 2020.

(51) Int. Cl. F41H 11/05; G05D 1/02

(52) U.S. Cl. CPC F41H 11/05; G05D 1/0206

(57) ABSTRACT

A waterbody access barrier system has one or more floating barrier segments, and a first floating gate segment for blocking an opening in the barrier system. The first floating gate segment has a latching system to connect it to a capture gear, which is at a fixed barrier termination point or on a second floating gate segment. One or more thrusters are mounted on at least the first floating gate segment. The latching system, and the thrusters, are autonomously or semi-autonomously controlled by a control system, which receives positional signals, for example from a global positioning system (GPS) and/or a light detection and ranging system (LiDAR) operatively connected to the first floating gate segment, and moves the first floating gate segment accordingly.

### CROSS REFERENCE TO RELATED APPLICATIONS

This non-provisional United States patent application claims priority to U.S. provisional patent application Ser. 63/092,576, filed Oct. 16, 2020 for all purposes. The disclosure of that provisional patent application is incorporated herein by reference, to the extent not inconsistent with this disclosure and claims.

### BACKGROUND—FIELD OF THE INVENTION

This invention relates to barrier systems to prevent unauthorized vessel access to a defined area, such as a harbor; or vessel passage along a river, canal or similar waterbody.

### BRIEF DESCRIPTION OF THE DRAWINGS

FIG. 1 is a view of a waterbody access barrier system embodying the principles of the present invention.

FIG. 2 shows further details of the system of FIG. 1.

FIGS. 3-5 show an opening sequence of the floating gate segment.

FIGS. 6-10 show a closing sequence of the floating gate segment.

FIG. 11 shows various components of the control/thruster and related systems.

FIG. 12 shows additional details of the floating gate segment, locking device and latch.

FIGS. 13 and 14 show additional detail of the locking device and latch.

FIG. 15 shows the thrusters in operation.

FIG. 16 shows the waterborne drone assisted latching system.

FIGS. 17 and 18 show a center opening barrier system.

### DESCRIPTION OF THE PRESENTLY PREFERRED EMBODIMENT(S)

While various barrier systems can embody the principles of the present invention, with reference to the drawings some of the presently preferred embodiments can be described.

The Unmanned Barrier Gate (UBG) barrier system may comprise three broad components: (1) an autonomous surface vessel control and guidance system, (2) a powered thruster system guided by the autonomous or semi-autonomous control system, and (3) a gate latching mechanism.

The UBG may be connected to or built into a waterside security barrier system. The system provides for an unmanned and autonomous, or semi-autonomous, opening and closing barrier gate operations. The system may be programmed to open and close on command, or through direct control from a remote location away from the barrier. Upon the gate reaching the closure point at an adjacent barrier segment, mooring buoy, pile, or other barrier termination, the system completes a latching sequence to secure the barrier in position.

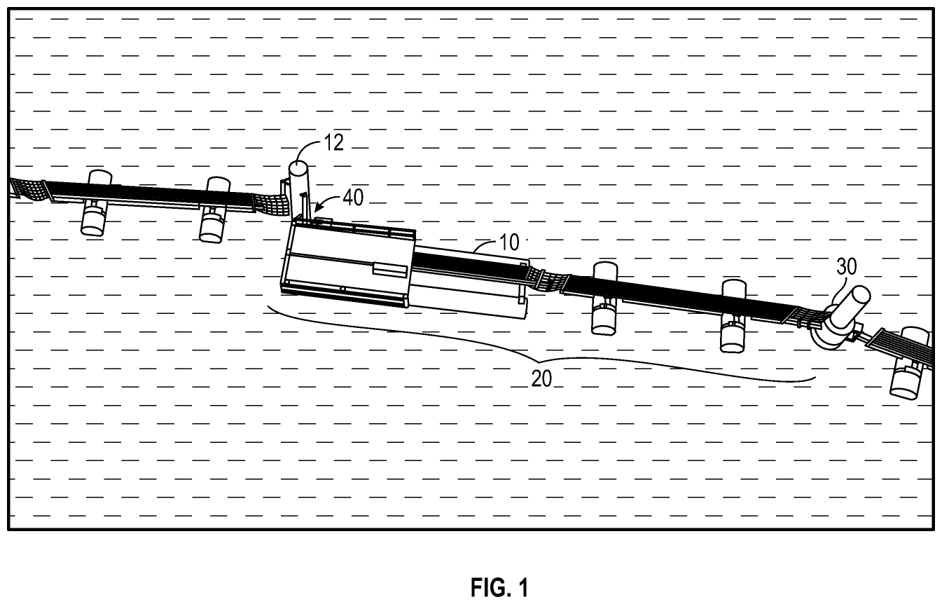

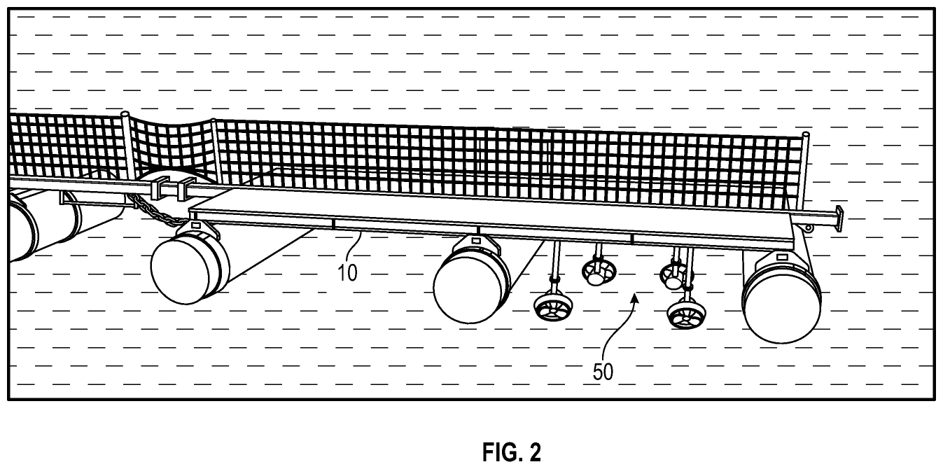

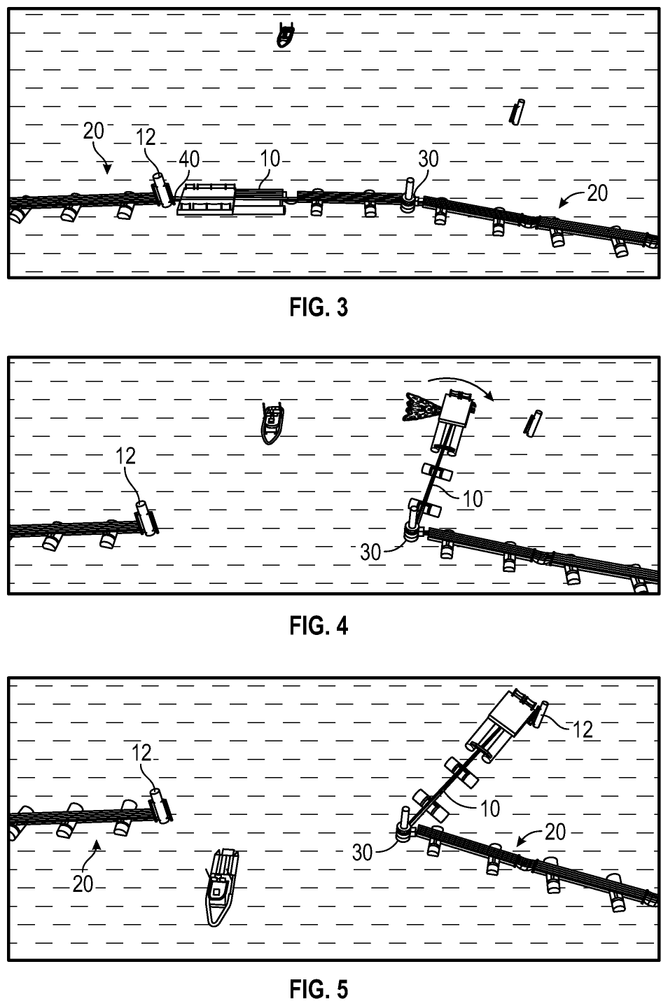

With reference to the drawings, various aspects of the system may be described. Referring to FIGS. 1 and 2, waterbody access barrier system, preferably with automated or semi-automated (autonomous) gate segment opening and closing functions, referred to generally as floating gate segment 10, is one component in an overall barrier system 20. Floating gate segment 10, in a presently preferred embodiment, consists of a segment of the overall barrier system 20, floating gate segment 10 preferably comprising a hinge 30 at one end and a latch 40 at the other end. Hinge 30 connects floating gate segment 10 to a barrier termination 12 (by way of example, a buoy, piling, adjacent floating segment, etc.), and allows rotation of floating gate segment 10 from a first, closed position as seen in FIG. 3, to a second, open position as seen in FIG. 4.

Locking device 70 comprises a latch 40. Latch 40 may be any form of latching mechanism to join floating gate segment 10 to a barrier termination 12, in order to close and secure the gate segment. For example, the latch may be a horizontally moving plunger/recess arrangement; a vertically moving plunger/eye arrangement; a rotating or swinging arm; or any other suitable latch. It is understood that the moving latch components and stationary latch components may be either on floating gate segment 10 or barrier termination 12.

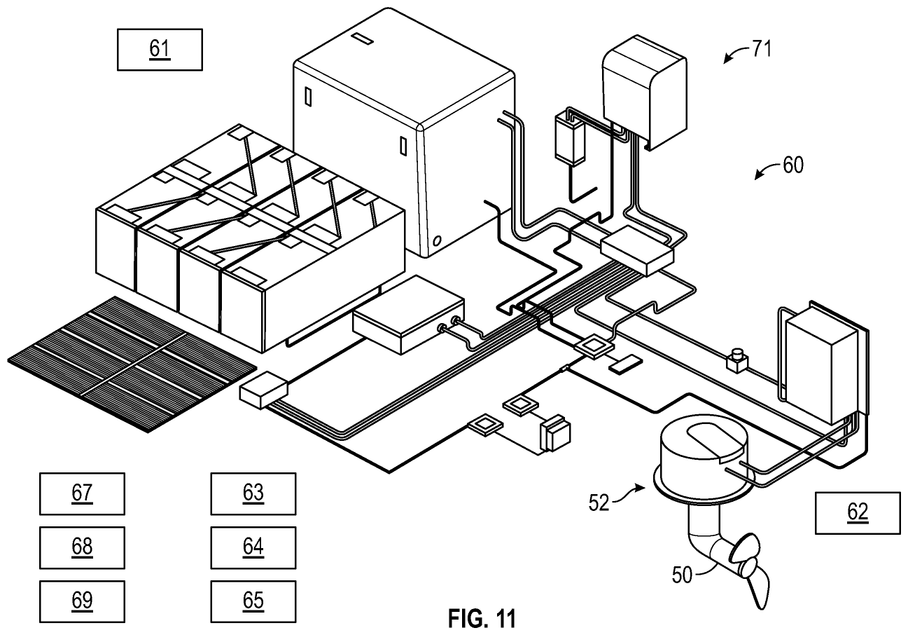

In an exemplary embodiment, latch 40 comprises two primary components, namely a striker 42 fixed to floating gate segment 10, and a capture gear 44 on the barrier termination 12, to which floating gate segment 10 is secured in the closed position. Floating gate segment 10 is moved between the closed and open positions by thrusters 50, controlled by an autonomous or semi-autonomous control system, designated generally as 60, also shown in FIG. 11 and described in more detail below. It is understood that power units 52 are functionally connected to thrusters 50; power units 52 may comprise electric generators and electric motors, hydraulic pumps and hydraulic motors, or any other suitable means for driving thrusters 50.

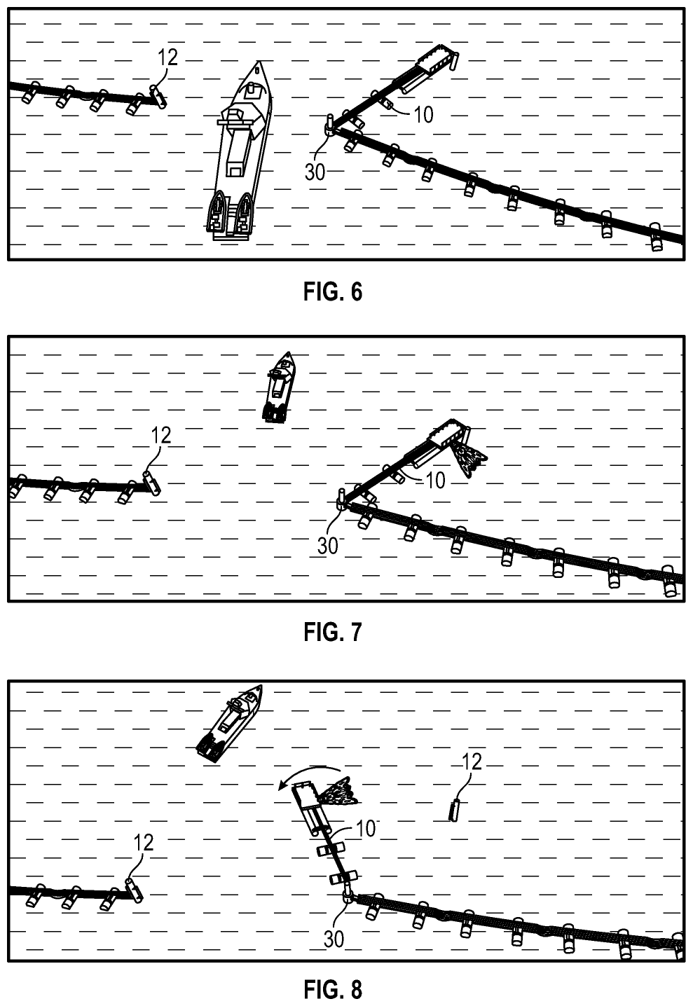

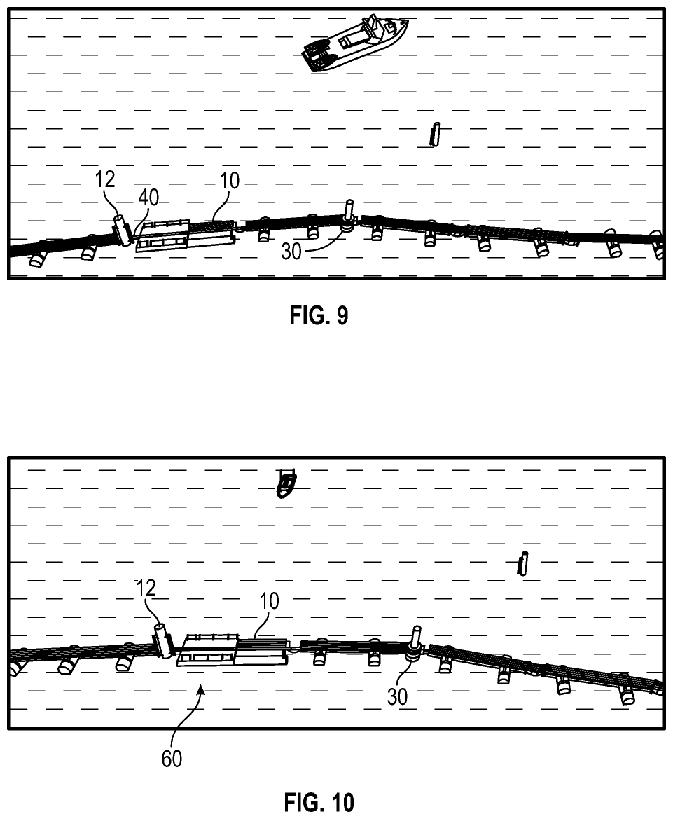

By way of example, the length of floating gate segment 10 may be between 400 feet and 1,500 feet. From the first, closed position, as shown in FIG. 3, locking device 70 and latch 40 can be unlocked to allow floating gate segment 10 to rotate around hinge 30, as in FIG. 4, to create an opening in barrier 20, as shown in FIG. 5. From the second, open position, after passage of a vessel through the opening, floating gate segment 10 can be maneuvered via thrusters 50 controlled by the control system 60 into a closed position, as in FIG. 9, and latched in the closed position, thereby securing barrier 20 from vessel passage. Generally, FIGS. 3 through 10 illustrate an unlatching, opening, closing, and latching sequence of floating gate segment 10.

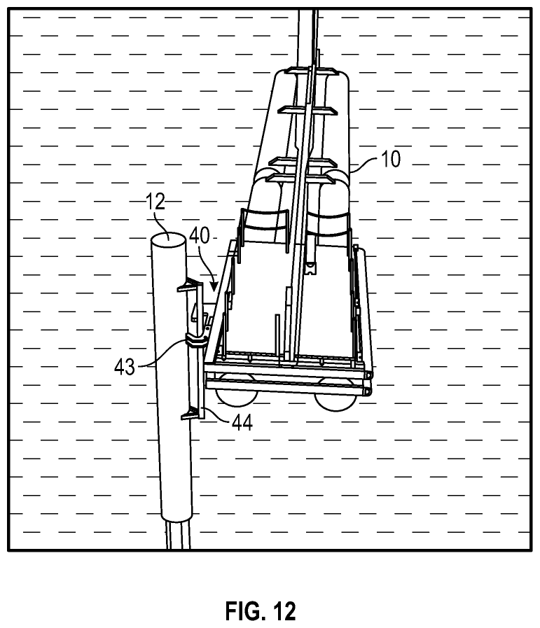

FIGS. 12, 13 and 14 show more detail of various embodiments of locking device 70, and especially latch 40. Generally, latch 40 comprises a striker 42, which engages a capture gear 44 attached to barrier termination 12. Capture gear 44 may be any structure engageable by striker 42 and hook shaped member 43, such as a bar, pole, ring, etc., and may be fixed to a piling, adjacent floating segment, buoy, or any other suitable mounting structure.

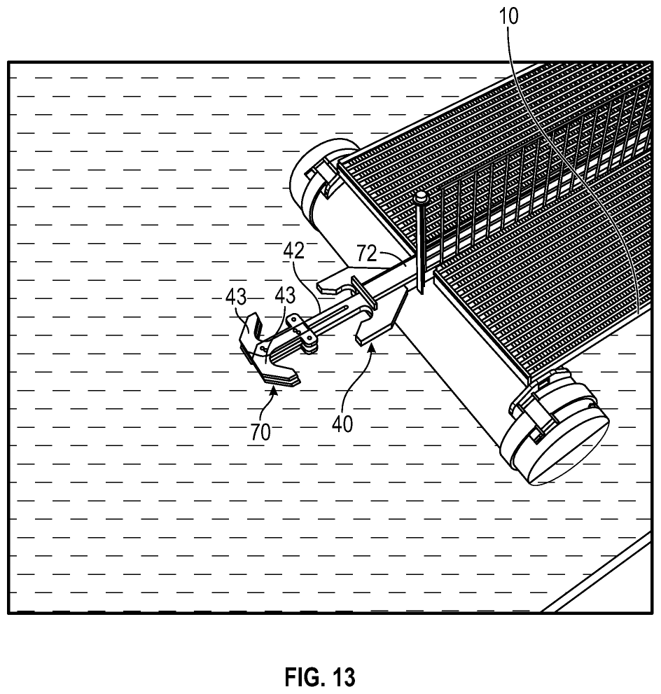

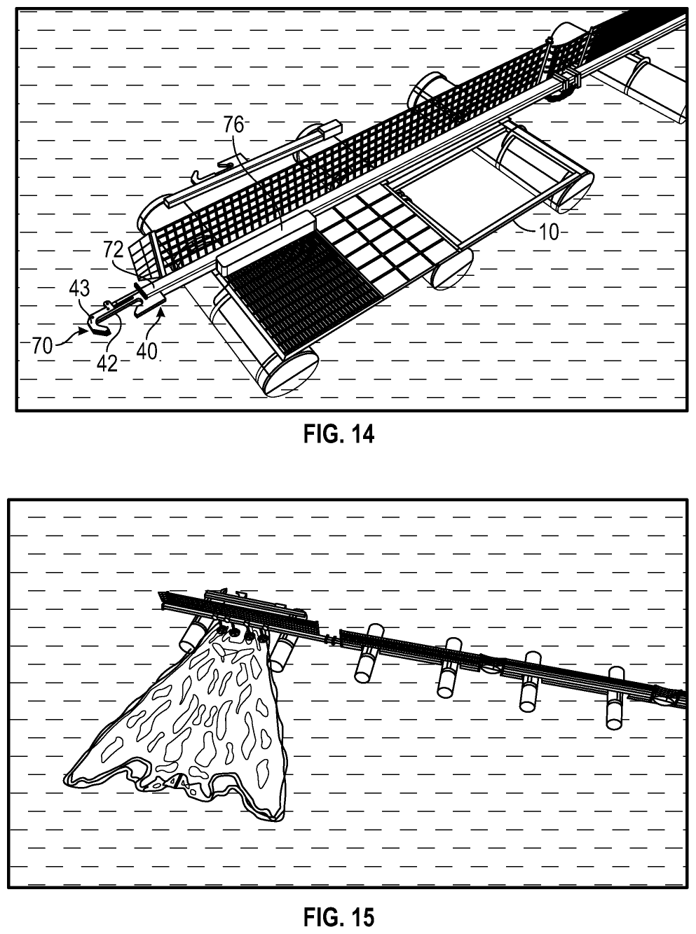

FIGS. 13 and 14 show more detail regarding embodiments of striker 42. Generally, striker 42 comprises a hook-shaped member 43, which as can be readily understood hooks around capture gear 44. FIG. 13 shows a “double sided” striker 42, with a pair of opposed hook-shaped member 43, so that gate 10 can more readily latch capture gear 44 when being closed from either direction. FIGS. 12 and 14 show a single-sided striker 42, with a single hook-shaped member 43. It is understood that in either embodiment, hook-shaped member 42 by linear actuators 76 (controlled by control system 60, as further addressed below) is extended to the degree necessary to engage capture gear 44, then hook-shaped member 42 is retracted by linear actuators 76 to securely fix gate 10 to barrier termination 12.

### Compound Automated Gate

Preferably, gate 10 comprises a compound automated gate latch 40. As used in this application, the term “compound” refers to a first or primary movement of floating gate 10 to a position fairly close to barrier termination 12, by thrusters 50 and related apparatus; then a second or secondary movement of floating gate 10 to a closed position, by an extended locking device 70/latch 40, capable of spanning the remaining distance from floating gate 10 to barrier termination (and more specifically, capture gear 44), or alternatively by a floating drone or similar means, which carries a cable from floating gate segment 10 to barrier termination 12, after which a winch on floating gate segment 10 retracts the cable, thereby pulling floating gate segment 10 into position for latch 40 to engage capture gear 44.

In more detail, in this embodiment, floating gate segment 10 is moved from the second, open position to the first, closed position with an integrated compound action, comprising a primary movement to move floating gate segment 10 most of the distance to the closed position; combined with a secondary movement to move gate 10 the remaining distance and latch gate 10 closed and secured.

An objective of the primary movement is to maneuver striker 42 to the general proximity, for example within 50 feet, of capture gear 44. In a preferred embodiment, primary movement is provided by in-water thruster(s) 50 with navigation by global positioning system (GPS), light detection and ranging (LiDAR) or other optical guidance, and/or pre-programmed logic, all of which are represented generally by control system 60.

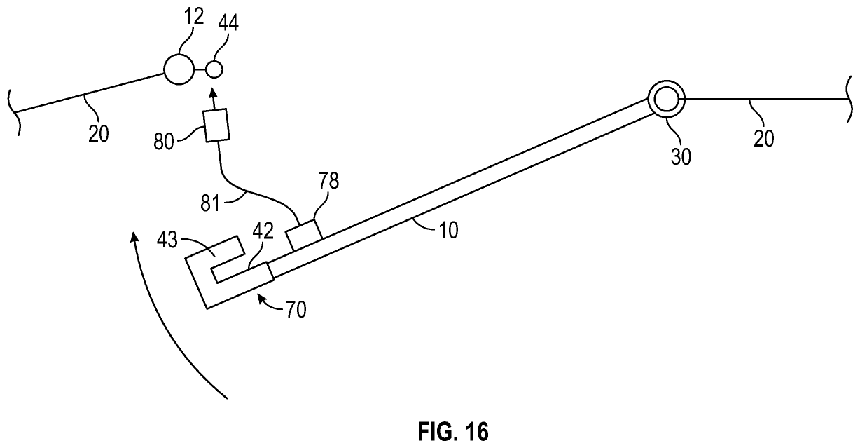

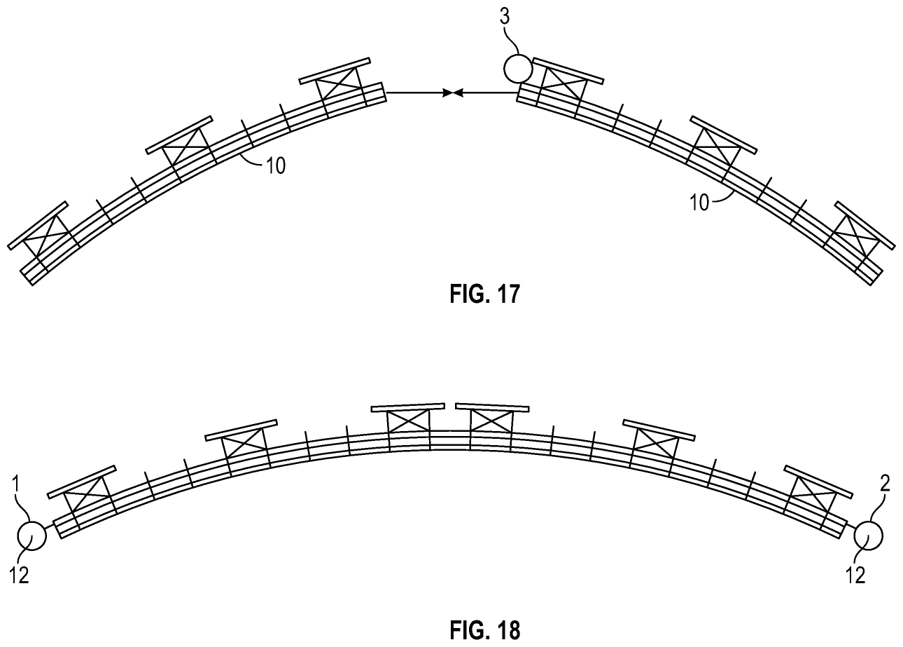

After striker 42 is maneuvered within the desired distance to capture gear 44, the secondary movement or function is engaged, and locking device 70 is deployed. Locking device 70 can be either an extendable mechanical boom 72, as can be seen in FIG. 16, or an autonomous floating drone 80 with a winch line payout spool, shown in FIG. 18. Locking device 70 spans the gap between striker 42 and capture gear 44, and then moves striker 42 into engagement with capture gear 44. In one embodiment, striker 42 is pulled into engagement with capture gear 44 via linear actuators 76 or similar mechanical means moving boom 72. In another embodiment, depicted generally in FIG. 16 floating gate segment 10 and striker 42 are moved into position by a powered winch 78 mounted near the latch end of floating gate segment for example with the assistance of a floating drone 80, which moves a cable or line 81 into engagement with barrier termination 12, then winch 78 can retract the cable or line, pulling floating gate segment 10 and striker 42 into position to connect to capture gear 44.

In another embodiment, barrier 20 may comprise a pair of floating gate segments 10, as shown in FIGS. 17 and 18. In this embodiment, floating gate segments 10 are opened and closed generally in the middle of the opening, although it is understood that gates may be of differing lengths adding up to the total required length (e.g. a 60/40 split, rather than equal length gates). Two (or even more) gates present various advantages, including but not limited to:
ability to use existing buoys;
lower thruster loads, e.g. thruster loads on a half-length gate will generally be only ½ the thruster load on a full length gate;
same or very similar thruster design for each gate;
hydrodynamic properties for a half-length gate ease the movement, especially closing, of the half-length gate; and
when open, the half-length gates extend only half the distance into the waterway as a full length gate.

### Control System; Latch Actuation; Thruster Power/Operation; Positional System

Control system 60, shown in FIG. 11, which is preferably wireless, comprises a plurality of elements related to operation of the latch system; the thruster system; and the various positional detection and control elements.

Referring to FIG. 11, which represents a number of these elements in schematical form, control system 60 comprises a power system 61 which provides electrical and/or hydraulic power to thrusters 50, along with thruster power unit 52. A thruster position and thrust level element 62 communicates with control system 60 to give information regarding the position or orientation of thrusters 50, and the degree of thrust being generated.

A GPS element 63 comprises a transmitter 64, typically mounted on floating gate segment 10, and a receiver 65 receiving signals from transmitter 64, to yield positional information regarding floating gate segment 10. Based on positional information, control system 60 can adjust direction and thrust level of thrusters 50, so as to maneuver floating gate segment 10 as needed. It is understood that positional information regarding barrier termination 12, and more specifically capture gear 44, are also inputs to control system 60.

Preferably, control system 60 also comprises a light detection and ranging system (LiDAR) 66, comprising emitters and receivers as required, to provide additional positional information regarding floating gate segment 10.

Control system 60 further comprises latch control element 67 which controls linear actuators 76, latch 40 and hook shaped member 43, namely extension and retraction thereof, so as to latch floating gate segment as needed.

Control system 60 further comprises drone control element 68, which receives positional information from drone 80 and transmits directional signals to drone 80. Winch control element 69 controls winch 78.

Control system 60 comprises digital processors, controls, communication elements and other elements as known in the art to implement the controls above, shown globally as element 71.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof.

Therefore, the scope of the invention is to be determined not by the illustrative examples set forth above, but by the appended claims and their legal equivalents.

We claim:

1. A waterbody access barrier system, comprising:
a floating barrier comprising one or more connected floating segments;
a floating gate segment spanning an opening in said barrier;
a latch adapted to join said floating gate segment to an adjacent barrier segment, thereby closing said opening when so joined;
one or more thrusters operatively connected to said floating gate segment and adapted to move said floating gate segment between a first, closed position and a second, open position;
a wireless control system operatively connected to said floating gate segment, said latch and said thrusters, said control system comprising one or more digital processors and positional detection systems, whereby said latch and said thrusters are autonomously or semi-autonomously operated to position said floating gate segment and engage said latch.

2. A waterbody access barrier system, comprising:
a floating barrier comprising one or more connected floating segments;
a floating gate segment spanning an opening in said barrier, one end of said opening comprising a barrier termination having a capture gear with which said floating gate section connects;
said floating gate segment comprising a locking device, said locking device comprising a latch, said latch comprising a striker section and a hook shaped member, and one or more linear actuators adapted to extend and retract said latch, whereby said hook shaped member engages said capture gear;
one or more thrusters operatively connected to said floating gate segment and adapted to move said floating gate segment between a first, closed position and a second, open position;
a wireless control system operatively connected to said floating gate segment, said locking device and said thrusters, said control system comprising one or more digital processors and positional detection systems, whereby said locking device and said thrusters are autonomously or semi-autonomously operated to position said floating gate segment with respect to said barrier termination and engage said locking device with said capture gear.

3. The system of claim 2, wherein said positional detection system comprises a global positioning system (GPS), further comprising a transmitter mounted on said floating gate segment and a receiver receiving GPS signals from said transmitter, said control system adapted to autonomously or semi-autonomously control said thrusters and position said floating gate segment based on said GPS signals.

4. The system of claim 3, wherein said control system further comprises a light detection and ranging system (LiDAR) providing positional information to said control system, said control system adapted to autonomously or semi-autonomously control said thrusters and position said floating gate segment based on signals from said LiDAR system.

5. The system of claim 4, wherein said locking device comprises an extendable boom on which said striker section and said hook shaped member are mounted, whereby when said floating gate segment is positioned by said thrusters such that said capture gear is within reach of said extendable boom when extended, said extendable boom is operated to engage said striker section and said hook shaped member with said capture gear.

6. The system of claim 4, further comprising a powered winch mounted on said floating gate segment having a cable spooled thereon, and a floating drone controlled by said control system and adapted to extend said cable from said winch and engage said cable with said barrier termination, whereby said powered winch can retract said cable and bring said floating gate segment into position so that said locking device can engage said capture gear.

7. A waterbody access barrier system, comprising:
a floating barrier comprising one or more connected floating segments;
a first floating gate segment spanning an opening in said barrier, one end of said opening having a capture gear with which said floating gate section connects;
said first floating gate segment comprising a locking device, said locking device comprising a latch mounted on an extendable boom, said latch comprising a striker section and a hook shaped member, and one or more linear actuators adapted to extend and retract said latch, whereby said hook shaped member engages said capture gear;
one or more thrusters operatively connected to said first floating gate segment and adapted to move said floating gate segment between a first, closed position and a second, open position;
a wireless control system operatively connected to said first floating gate segment, said locking device and said thrusters, said control system comprising one or more digital processors and positional detection systems, whereby said locking device and said thrusters are autonomously or semi-autonomously operated to position said floating gate segment with respect to said barrier termination and engage said locking device with said capture gear;
wherein said positional detection system comprises a global positioning system (GPS), further comprising a transmitter mounted on said first floating gate segment and a receiver receiving GPS signals from said transmitter, said control system adapted to autonomously control said thrusters and position said first floating gate segment based on said GPS signals in order for said locking device to engage said capture gear, thereby securing said first floating gate segment.

8. The system of claim 7, wherein said control system further comprises a light detection and ranging system (LiDAR) providing positional information to said control system, said control system adapted to autonomously or semi-autonomously control said thrusters and position said first floating gate segment based on signals from said GPS system and said LiDAR system.

9. The system of claim 7, further comprising:
a second floating gate segment comprising said capture gear;
one or more thrusters operatively connected to said second floating gate segment and adapted to move said second floating gate segment between a first, closed position and a second, open position;
a wireless control system additionally operatively connected to said second floating gate segment and said thrusters, said control system comprising one or more digital processors and positional detection systems, whereby said locking device and said thrusters are autonomously or semi-autonomously operated to position said second floating gate segment with respect to said first floating gate segment and engage said locking device with said capture gear;
wherein said positional detection system comprises a global positioning system (GPS), further comprising a transmitter mounted on said floating gate segment and a receiver receiving GPS signals from said transmitter, said control system adapted to autonomously or semi-autonomously control said thrusters and position said second floating gate segment based on said GPS signals in order for said locking device to engage said capture gear, thereby securing said first and second floating gate segments.

10. The system of claim 9, wherein said control system further comprises a light detection and ranging system (LiDAR) providing positional information to said control system, said control system adapted to autonomously or semi-autonomously control said thrusters and position said first and second floating gate segments based on signals from said GPS system and said LiDAR system.

11. A method of controlling access to a waterbody, comprising the steps of:
a. providing a waterbody access barrier system, comprising:
a floating barrier comprising one or more connected floating segments;
a floating gate segment spanning an opening in said barrier;
a latch adapted to join said floating gate segment to an adjacent barrier segment, thereby closing said opening when so joined;
one or more thrusters operatively connected to said floating gate segment and adapted to move said floating gate segment between a first, closed position and a second, open position;
a wireless control system operatively connected to said floating gate segment, said latch and said thrusters, said control system comprising one or more digital processors and positional detection systems, whereby said latch and said thrusters are autonomously or semi-autonomously operated to position said floating gate segment and engage said latch;
wherein said positional detection system comprises a global positioning system (GPS), further comprising a transmitter mounted on said first floating gate segment and a receiver adapted to receive GPS signals from said transmitter, said control system further comprising a light detection and ranging system (LiDAR) providing positional information to said control system, said control system adapted to autonomously or semi-autonomously control said thrusters and position said first floating gate segment based on said GPS signals and positional information from said LiDAR system;
b. receiving, by said control system, said GPS signals and said LiDAR positional information;
c. processing, by said control system, said GPS signals and said LiDAR positional information;
d. controlling, by said control system, said thrusters so as to move said first floating gate segment to said first closed position;
e. operating, by said control system, said latch, thereby securing said first floating gate segment and closing said opening in said floating barrier.

12. The method of claim 11, wherein steps (d)-(e) are carried out autonomously or semi-autonomously by pre-programmed instructions.

13. The method of claim 12, wherein:
in step (a), said waterbody access barrier system further comprises a powered winch mounted on said first floating gate segment having a cable spooled thereon, and a floating drone controlled by said control system and adapted to extend said cable from said winch and engage said cable with said capture gear, whereby said powered winch can retract said cable and bring said floating gate segment into position so that said latch can engage; and
comprising the further step between steps (d) and (e) of:
d(1): controlling, by said control system, movement of said floating drone so as to extend said cable and engage said cable with a barrier termination, and move said first floating gate segment toward said first closed position.
